(19) United States
(12) Patent Application Publication
(10) Pub. No.: US 2020/0260908 A1
(43) Pub. Date: Aug. 20, 2020

(54) COOKING UTENSIL WITH RETRACTABLE SHIELD

(71) Applicant: Daniel J. Wells, St. Charles, IL (US)

(72) Inventor: Daniel J. Wells, St. Charles, IL (US)

(21) Appl. No.: 16/795,642

(22) Filed: Feb. 20, 2020

Related U.S. Application Data
(60) Provisional application No. 62/807,988, filed on Feb. 20, 2019.

(51) Int. Cl. A47J 36/36; A47J 43/18

(52) U.S. Cl. CPC A47J 36/36; A47J 43/18

(57) ABSTRACT

A utensil for cooking food disposed thereat includes a manipulator having a shaft and a holder disposed at a first end of the shaft. A shield is slidably disposed on the shaft and includes a shroud configured to at least partially surround the holder when the shield is in a first position and to expose the holder when the shield is in a second position. The holder is configured to hold a food item thereat. The shroud includes a metal sheet formed to at least partially circumscribe a longitudinal axis of the shaft. When the holder holds the food item and when the shield is in the first position, the shield at least partially surrounds the food item and the holder.

### CROSS REFERENCE TO RELATED APPLICATION

The present application claims the filing benefits of U.S. provisional application Ser. No. 62/807,988, filed Feb. 20, 2019, which is hereby incorporated herein by reference in its entirety.

### FIELD OF THE INVENTION

The present application relates generally to cooking utensils, and more particularly, to cooking utensils for cooking food items over an exposed flame.

### BACKGROUND OF THE INVENTION

Cooking utensils are often used to assist in preparing food using a heat source, allowing a user to distance him or herself safely away from the heat source. For instance, cooking utensils may be used in situations where the heat source includes an exposed flame, such as a campfire, while allowing the user to be distanced from the flame. However, cooking over an open flame may present challenges, as the flame presents a direct heat source that is relatively difficult to regulate, and may inconsistently cook food.

### SUMMARY OF THE INVENTION

The present application discloses a cooking utensil for cooking a food item over an exposed or open flame, such as a campfire. The utensil includes a movable or slidable shield element that can be selectively moved between a retracted position, where the food item is fully exposed at the end of the utensil, and an extended or shielding position, where the shield element or shroud at least partially circumscribes or surrounds the food item to limit or control heating of the food item when the shield element and food item are placed at the open flame. The shield element comprises a metal sheet (formed to the desired shape that circumscribes or at least partially circumscribes or surrounds the food item when the shield element is in the extended position) that optionally includes a plurality of apertures therethrough and optionally a plurality of different sized apertures therethrough to allow heat to pass through the shield element while limiting the flames from directly heating or burning the food item and providing enhanced and more uniform heating of the food item.

These and other objects, advantages, purposes and features of the present invention will become apparent upon review of the following specification in conjunction with the drawings.

### BRIEF DESCRIPTION OF THE DRAWINGS

The drawings described herein are for illustrative purposes only of selected configurations and are not intended to limit the scope of the present disclosure.

FIG. 1 is a perspective view of a cooking utensil according to the principles of the present disclosure;

FIG. 2 is a top plan view of the utensil of FIG. 1;

FIG. 3 is a bottom plan view of the utensil of FIG. 1;

FIG. 4 is an enlarged, fragmentary bottom plan view of the utensil of FIG. 1;

FIG. 5 is an enlarged view of the utensil of FIG. 1, showing an alternative example of a shaft of the utensil;

FIG. 6 is a perspective view of another example of a utensil according to the principles of the present disclosure;

FIG. 7 is a top plan view of the utensil of FIG. 6;

FIG. 8 is an enlarged, fragmentary top plan view of the utensil of FIG. 6;

FIG. 9 is a perspective view of another example of a utensil according to the principles of the present disclosure;

FIG. 10 is a top plan view of the utensil of FIG. 9;

FIG. 11 is a top plan view of a utensil similar to the utensil of FIG. 9, showing a shield of the utensil in a first position;

FIG. 11A is a perspective view of the utensil of FIG. 11;

FIG. 12 is a perspective view of the utensil of FIG. 11, showing the shield of the utensil in a second position;

FIG. 12A is a perspective view of the utensil of FIG. 12;

FIG. 13 is an enlarged, fragmentary view of the utensil of FIG. 9, showing the shield in the second position;

FIG. 14 is a top plan view of the utensil of FIG. 9, showing the shield in the first position;

FIG. 15 is a perspective view of another example of a utensil according to the principles of the present disclosure, showing a shield of the utensil in a first position; and

FIG. 16 is a perspective view of the utensil of FIG. 15, showing the shield of the utensil in a second position.

Corresponding reference numerals indicate corresponding parts throughout the drawings.

### DETAILED DESCRIPTION

Referring now to the drawings and the illustrative embodiments depicted therein, examples are shown of a utensil 10-10c for cooking including a manipulator or extendable support 12-12c and a shield or shroud 14-14c that is movable between a first position and a second position relative to the manipulator 12-12c. Generally, the shield 14-14c is configured to be moved between a first position and a second position to selectively expose and surround a food-holding portion of the manipulator 12-12c, as discussed in greater detail below.

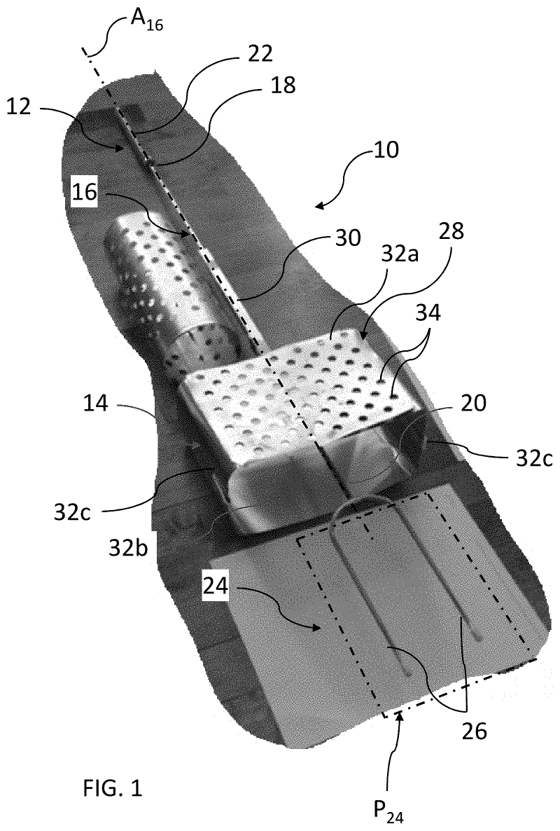

With reference to FIG. 1, a first example of the utensil 10 includes the manipulator 12 and the shield 14. The manipulator 12 includes a shaft 16 having a first end 18 and a second end 20 disposed at an opposite end of the shaft 16 from the first end 18. As shown, the shaft 16 is elongate, and defines a major longitudinal axis A16 extending from the first end 18 to the second end 20. In some examples, the shaft 16 may have a fixed length. In other examples, the shaft 16 may be a telescoping shaft, whereby the length of the shaft 16 can be adjusted by moving the shaft 16 between a retracted position and an extended position to accommodate various cooking environments and temperatures. For example, an outer shaft portion may slidably receive an inner shaft portion, with the handle at the end of the inner shaft portion and the tines or food holder at the end of the outer shaft portion, and with the shield slidably disposed at and along the outer shaft portion. Thus, a user can extend the shaft to a desired length (so as to be a safe distance from the flame) and may move the shield to the extended position at the food to control or limit heating of the food over the flame.

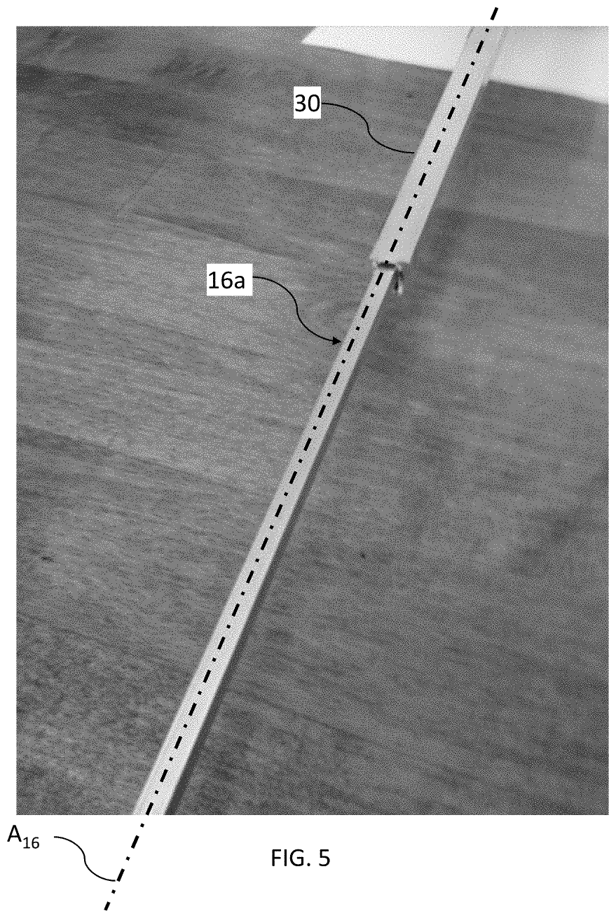

In the illustrated example, the shaft 16 is cylindrical (FIGS. 1-4), and has a circular cross-section (normal to the longitudinal axis A16). In some examples, the shaft may have a polygonal cross section, and have a plurality of sides. For example, the shaft may have a square cross-section, forming four sides (see shaft 16a in FIG. 5). In other examples, the cross-section of the shaft 16 may be irregularly shaped.

The manipulator 12 may include a handle 22 attached at the first end 18 of the shaft 16. In the illustrated example, the handle 22 is elongate and extends coaxially with the shaft 16 along the direction of the longitudinal axis A16. Accordingly, rotation of the handle 22 about the longitudinal axis A16 results in a corresponding rotation of the shaft 16 about the longitudinal axis A16. In the illustrated example, the handle 22 is substantially cylindrical in shape. However, in other examples, the handle 22 may be ergonomically formed to conform to a palm of a hand when the handle 22 is grasped. The handle 22 may be formed of an insulating material having a relatively low thermal conductivity, such as wood or a polymeric material or may comprise a metallic material (such as aluminum or the like) with a thermally insulating layer surrounding the metallic portion of the handle.

With continued reference to FIG. 1, the manipulator 12 includes a holder 24 disposed at the second end 20 of the shaft 16 and configured to hold one or more pieces of food. In the illustrated example, the holder 24 includes one or more tines or prongs 26 extending parallel to the longitudinal axis A16 of the shaft 16. The prongs 26 are spaced apart from each other on opposite sides of the longitudinal axis A16 to form a multi-pronged fork that is rotatable about the longitudinal axis A16. In other examples, the holder 24 may include a single prong 26 coaxially aligned (or not coaxially aligned) with the longitudinal axis A16. Alternatively, the holder 24 may include a rack or basket configured to contain food items therein. In some examples, the holder 24 may be removably attached to the second end 20 of the shaft 16, whereby different configurations of holders 24 can be interchanged on a common or universal shaft.

With continued reference to the example of the utensil 10 shown in FIGS. 1-5, the shield 14 of the utensil 10 is movable along the shaft between a retracted first position where the holder 24 is exposed (FIG. 1), and an extended second position where the holder 24 is at least partially concealed by the shield 14 (not shown). Accordingly, the shield 14 can be moved to the first or retracted position to allow food to be provided to or removed from the holder 24, or to allow the food to be presented directly to the heat source (e.g., a flame). The shield 14 can be moved to the second or extended position to cover the food during cooking, thereby providing a thermal buffer between the heat source and the food.

The shield 14 includes a shroud 28 and a sleeve 30 connected to the shroud 28. The shroud 28 is configured to at least partially surround the holder 24 when the shield 14 is in the extended second position, while the sleeve 30 is configured to provide a sliding interface between the shield 14 and the manipulator 12. The cross-sectional shape of the inner surface of the sleeve thus corresponds to the cross-sectional shape of the shaft (e.g., circular or polygonal).

In the illustrated example, the shroud 28 has a polygonal cross section relative to the longitudinal axis A16 of the shaft 16, and includes a plurality (such as four in the illustrated example) of sides 32a, 32b, 32c that are each configured to be spaced outwardly from the holder 24 by a predetermined distance when the shield 14 is in the second position. Particularly, the shroud 28 is rectangular-shaped and includes a first side 32a parallel to and spaced apart from a central plane P24 defined by the holder 24 (i.e., the plane extending through the two prongs 26). The shroud 28 further includes a second side 32b parallel to and spaced apart from the plane P24 of the holder 24 in an opposite direction from the first side 32a. The shroud 28 further includes an opposing pair of third sides 32c formed on opposite sides and each connecting the first side 32a to the second side 32b.

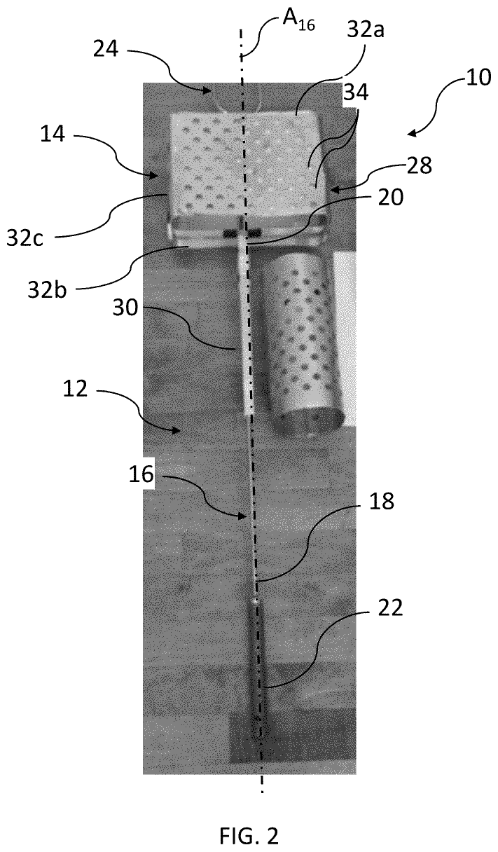

With reference to FIGS. 1 and 2, the first side 32a of the shroud 28 includes a plurality of perforations 34 formed through an entire thickness of the first side 32a. In the illustrated example, each of the perforations 34 is cylindrical (but they could be any shape and pattern depending on the application and desired function and appearance). The perforations 34 are arranged in a regular pattern along an entirety of the first side 32a. For example, in the illustrated example the perforations 34 are arranged in a series of columns (i.e., parallel to the longitudinal axis A16) that are alternatingly staggered or offset with respect to each other. Alternatively, the perforations 34 may be described as including a plurality of diagonally-extending rows, whereby each row includes a plurality of evenly-spaced perforations 34 extending from a first edge of the first side 32a to a second edge of the first side 32a.

Each of the perforations 34 is sized to suitably regulate thermal transfer through the first side 32a of the shroud 28. Here, a cross dimension of the perforations 34 ranges from 0.125 inches to 0.500 inches, but could be less than 0.125 inches. However, in other examples, different sizes of perforations 34 may be used to provide more or less exposure through the first side 32a of the shroud 28.

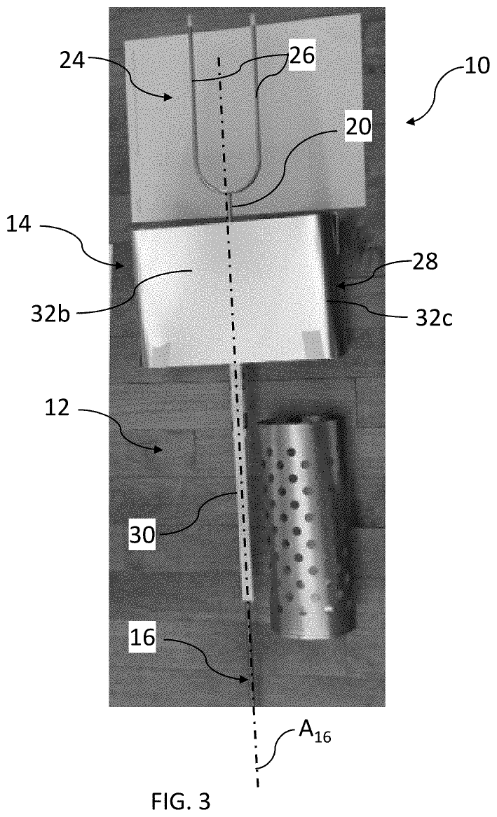

Referring now to FIGS. 1 and 3, the second side 32b and the third sides 32c of the shroud 28 are provided without perforations. Accordingly, the second side 32b and the third sides 32c are solidly formed and provide a greater thermal buffer between the food and the heat source than the perforated first side 32a. In use, the manipulator 12 and/or the shroud 28 can be rotated about the longitudinal axis A16 to selectively present the perforated first side 32a or the unperforated second side 32b to the heat source (and optionally the unperforated second side may have different sized apertures or apertures arranged in a different pattern as compared to the first side), such that the presentation of one side versus the other may result in different cooking characteristics when the food item is held over or in the flame, thereby allowing the user to choose between desired amounts of temperature regulation while cooking using the utensil.

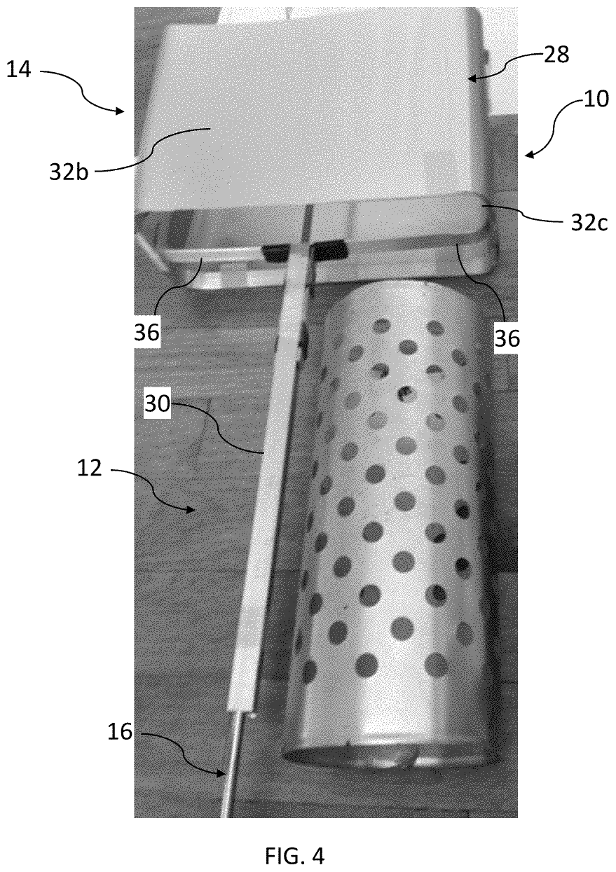

As best shown in FIGS. 4 and 5, the sleeve 30 is connected to an end of the shroud 28 facing the first end 18. Particularly, the sleeve 30 is connected to at least two of the sides 32a, 32b, 32c by a plurality of spokes 36, and slidably interfaces with the shaft 16 to allow the shroud 28 to move between the first position and the second position. In some examples, the sleeve 30 defines a conduit (not shown) through which the shaft 16 is slidably received. In some examples, the sleeve 30 and the shaft 16 cooperate to control rotation of the shield 14 relative to the manipulator 12 about the longitudinal axis A16. For example, where the shaft 16 is cylindrical (FIG. 4), the sleeve 30 may be configured to rotate freely about the shaft 16 such that the first side 32a and the second side 32b can be selectively presented to the heat source by rotating the shield 14 and not the manipulator 12.

Alternatively, the sleeve 30 and the shaft 16 may be configured to limit rotation of the shield 14 relative to the manipulator 12. For example, where the shaft 16 is provided with a polygonal or irregular cross-sectional shape (FIG. 5), the conduit of the sleeve 30 may have a corresponding non-circular or irregular cross-sectional shape, whereby the sides of the shaft 16 interface with sides of the conduit to limit relative rotation. Here, the user selectively presents the first side 32a or the second side 32b by rotating the manipulator 12, which results in corresponding rotation of the shield 14.

Thus, the utensil 10 comprises a shroud that is non-cylindrical or rectangular in shape so as to circumscribe a food item or items held at the holder end of the shaft. Parts of the shroud may have holes or perforations and/or parts of the shroud may not have holes or perforations. Optionally, the shroud may have different sized holes at different sides of the shroud to provide further options to the user for selectively heating the food item. For example, one side may have very small perforations, and another side may have larger perforations. For such applications where parts of the shroud has perforations of different sizes (and optionally with part of the shroud having no perforations), a user can rotate the shroud to provide the desired heating of the food item.

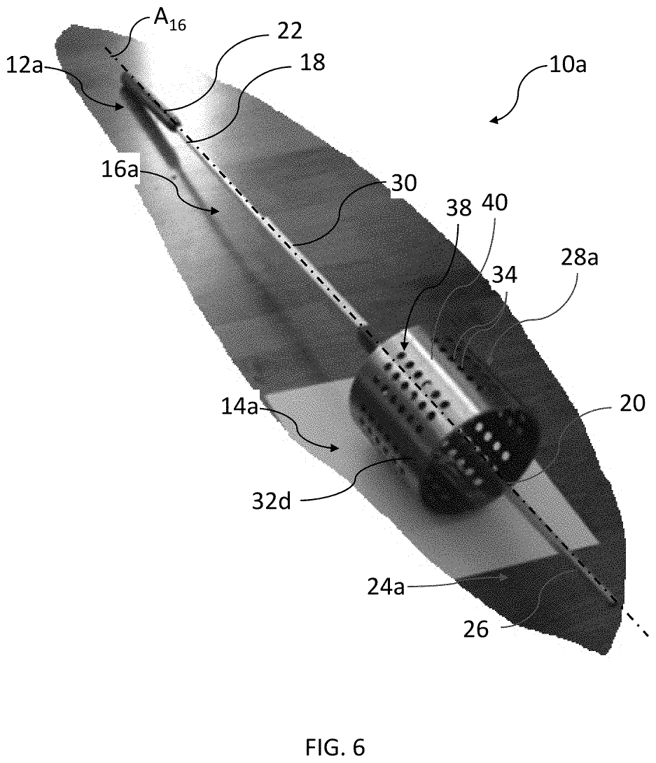

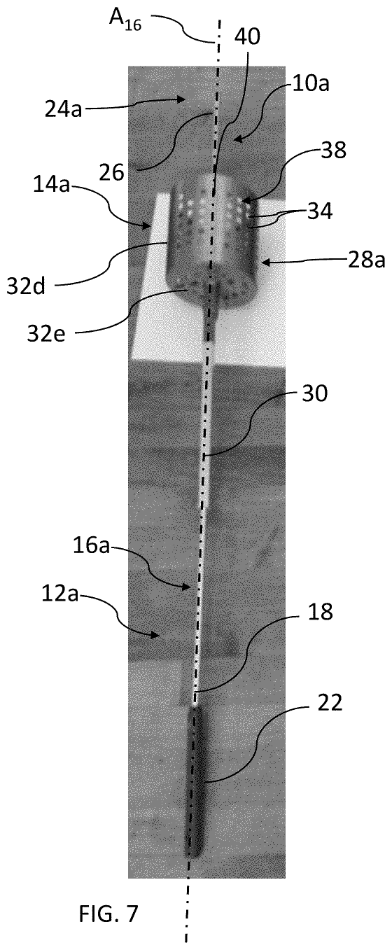

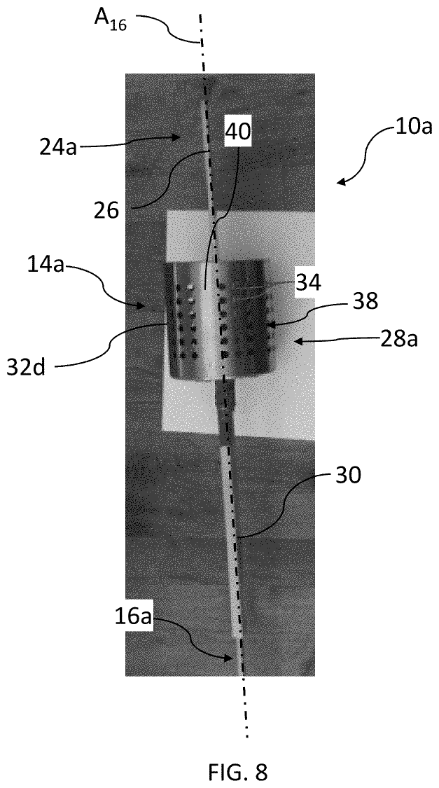

With particular reference to FIGS. 6-8, another utensil 10a is provided and includes a manipulator 12a and a shield 14a slidably received on the manipulator 12a. In view of the substantial similarity in structure and function of the components associated with the utensil 10 with respect to the utensil 10a, the same reference numerals are used hereinafter and in the drawings to identify the same or similar elements while the same reference numerals containing letter extensions are used to identify those elements that have been modified (e.g., 10a is used instead of 10 for the utensil of FIGS. 6-8).

Referring to FIG. 6, the manipulator 12a of the utensil includes a shaft 16a, the handle 22 attached to the first end 18 of the shaft 16a, and a holder 24a attached at the second end 20 of the shaft 16a. As discussed above, the holder 24a of the manipulator 12a includes a single prong 26 coaxially aligned with the shaft 16a along the longitudinal axis A16. In this example, the shaft 16a is formed with a square cross-section (see FIG. 5), and may be configured to limit rotation of the sleeve 30 about the shaft 16a.

With continued reference to FIGS. 6-8, the shroud 28a of the shield 14a includes a cylindrical sidewall 32d having a plurality of the perforations 34 formed therethrough. Here, the perforations 34 are arranged into a plurality of perforation groups 38 that are radially arranged about the circumference of the sidewall 32d. As shown, each one of the groups 38 includes a plurality of columns of the perforations 34 arranged parallel to the longitudinal axis A16. Adjacent ones of groups 38 are separated from each other by an unperforated portion 40, such that spacing between adjacent ones of the columns within each group 38 is less than the distance between the adjacent groups 38 that are formed on opposite sides of the unperforated portion 40.

Optionally, the shroud 28a of the utensil 10a may include an end wall 32e facing the first end 18 of the shaft 16a (and optionally, the shroud 28, discussed above, may include such an end wall). The end wall 32e is transverse to the longitudinal axis A16 and connects the sleeve 30 to the sidewall 32d. Thus, instead of providing the shroud 28a with an open end having spokes 26 connecting the sleeve 30 to the shroud 28, the end of the shroud 28a may be substantially covered by the end wall 32e. As shown, the end wall 32e includes a plurality of the perforations 34 formed therethrough (but it could be a solid or non-perforated wall).

Thus, the shroud 28a comprises a cylindrical sheet of metal having perforations established therethrough in a desired pattern. Optionally, the shroud may have different sized or different spaced perforations at respective regions or portions of the cylindrical shroud. For example, one portion or region (e.g., a third or quarter of the shroud) may be non-perforated, another portion or region may have small perforations (e.g., having a cross dimension of around 0.125 inches or less), and another portion or region may have larger perforations (e.g., having a cross dimension of around 0.25 inches or more). Thus, the user of the utensil 10a may rotate the utensil and shroud so that the desired degree of perforations (e.g., no perforations, smaller perforations, larger perforations) is at the lower part of the shroud and directly over the flames, in order to provide the desired heating and cooking of the food item.

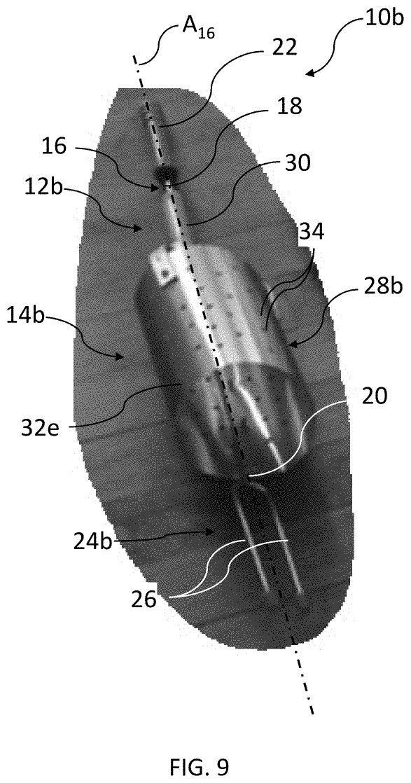

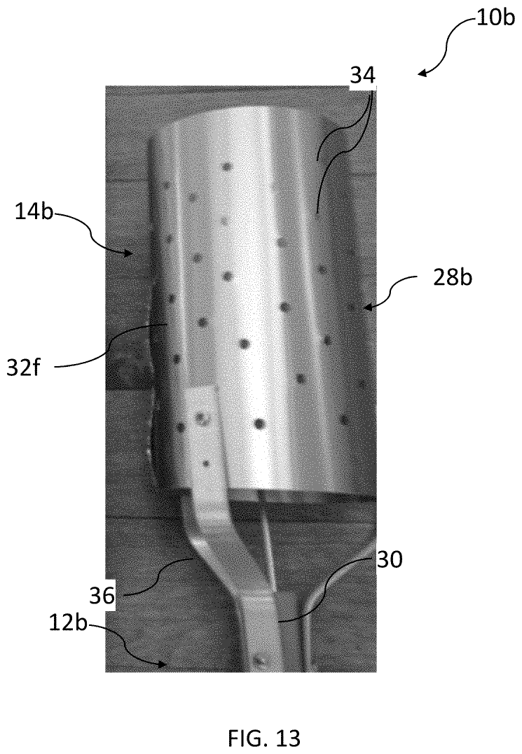

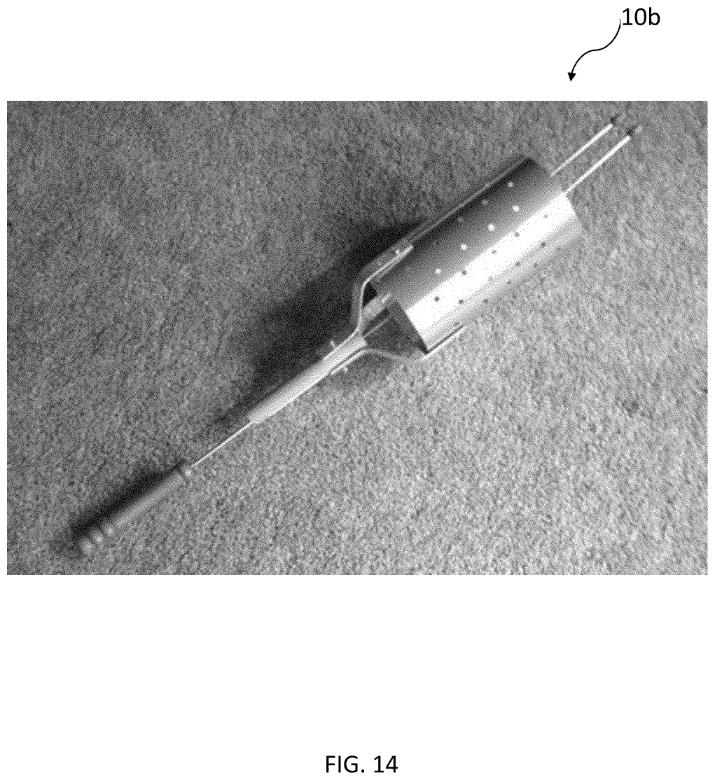

With reference to FIGS. 9-14, a utensil 10b is provided and includes a manipulator 12b and a shield 14b slidably received on the manipulator 12b. In view of the substantial similarity in structure and function of the components associated with the utensil 10 with respect to the utensil 10b, the same reference numerals are used hereinafter and in the drawings to identify the same or similar elements while the same reference numerals containing letter extensions are used to identify those components that have been modified (e.g., 10b is used instead of 10 for the utensil of FIGS. 9-14).

Referring to FIG. 9, the manipulator 12b of the utensil 10b includes the shaft 16, the handle 22 attached to the first end 18 of the shaft 16, and a holder 24b attached at the second end 20 of the shaft 16. In this example, the holder 24b is a fork having a pair of the prongs 26 spaced apart from each other on opposite sides of the longitudinal axis A16 of the shaft 16.

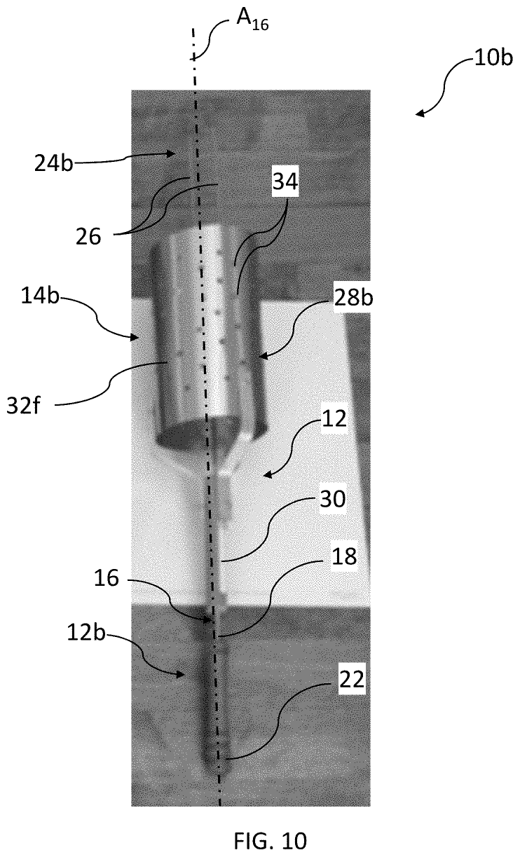

With continued reference to FIGS. 9-14, the shroud 28b of the shield 14b includes a cylindrical sidewall 32f having a plurality of the perforations 34 formed therethrough. Here, the perforations 34 are arranged into a regularly repeating pattern around the circumference of the sidewall 32f. For example, the perforations 34 may be arranged in a series of rows and/or columns that are regularly spaced around the entire circumference of the sidewall 32f. The shroud 28b is connected to the sleeve 30 by a plurality of the spokes 36 extending radially between the sleeve 30 and the sidewall 32f (FIG. 10).

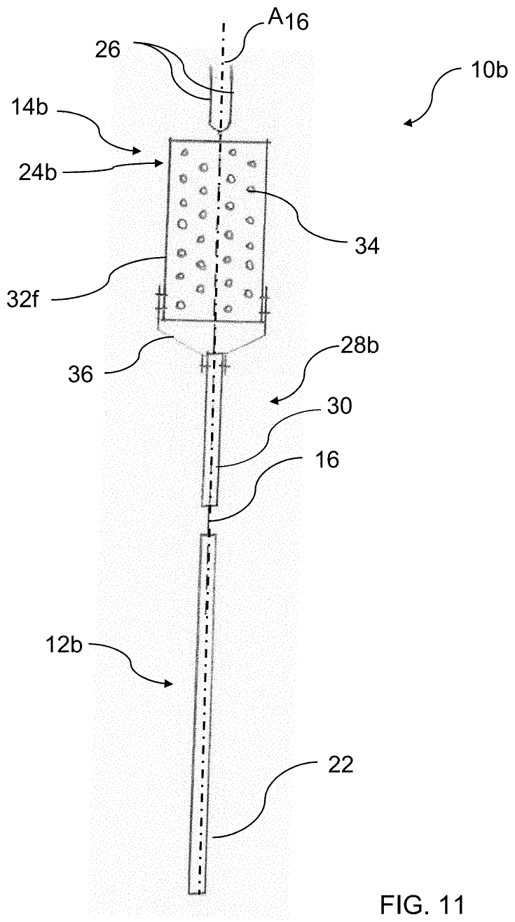

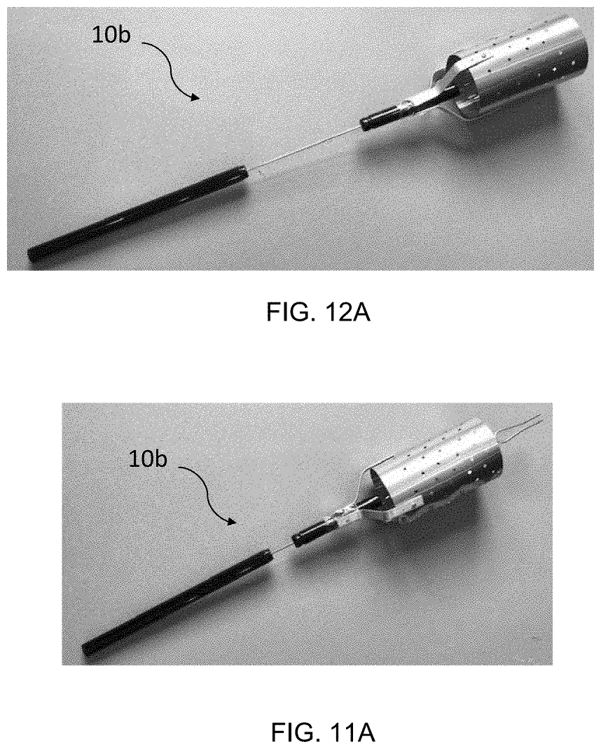

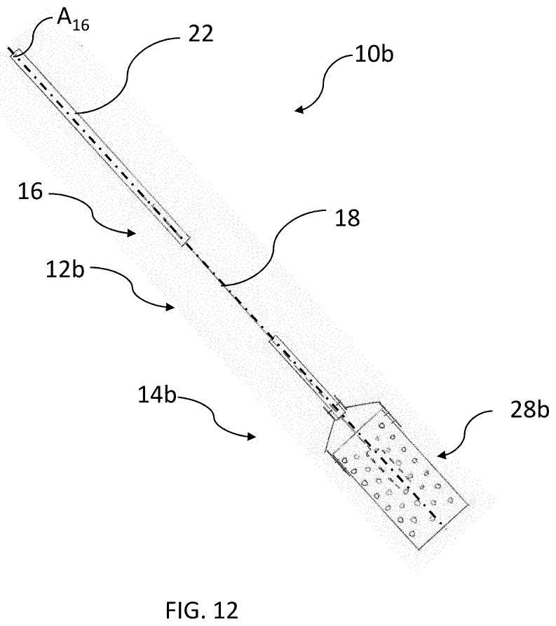

Optionally, and with reference to FIGS. 11, 11A, 12, and 12A, the handle 22 may comprise an elongated handle to provide enhanced stiffness to the utensil, such that a larger portion of the manipulator is not flexible. This results in a shorter exposed shaft 18, which reduces flexing or bending of the shaft during use of the utensil. The handle portion 22 may comprise any suitable material, and may comprise aluminum (to reduce weight of the utensil), with a thermally insulating sleeve or material disposed at least over the end of the handle portion where a user may grasp during use of the utensil when cooking a food item.

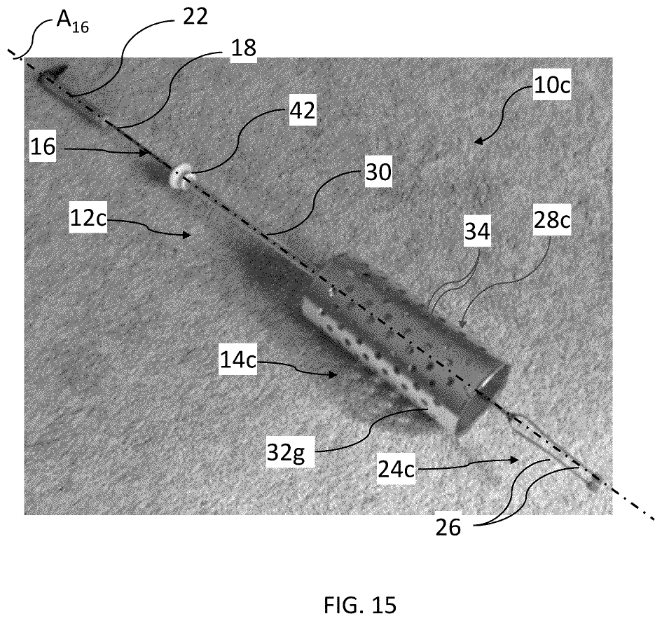

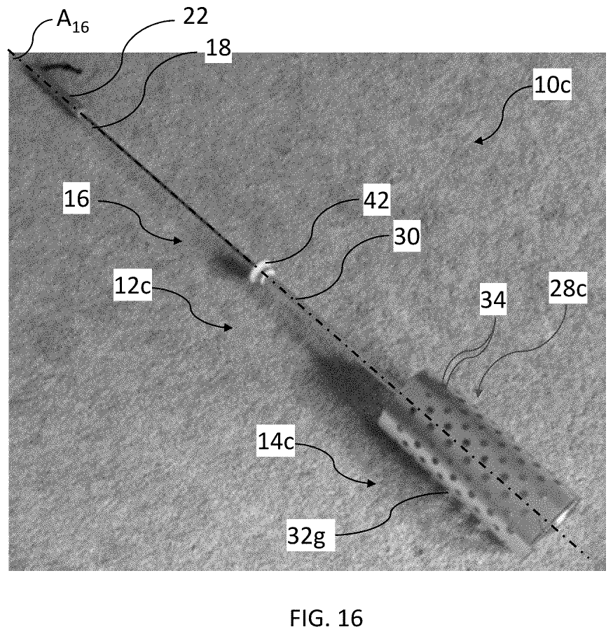

With particular reference to FIGS. 15 and 16, another utensil 10c is provided that includes a manipulator 12c and a shield 14c slidably received on the manipulator 12c. In view of the substantial similarity in structure and function of the components associated with the utensil 10 with respect to the utensil 10c, the same reference numerals are used hereinafter and in the drawings to identify the same or similar elements while the same reference numerals containing letter extensions are used to identify those components that have been modified (e.g., 10c is used instead of 10 for the utensil of FIGS. 15 and 16).

Referring to FIG. 15, the manipulator 12c of the utensil 10c includes the shaft 16, the handle 22 attached to the first end 18 of the shaft 16, and a holder 24c attached at the second end 20 of the shaft 16. In this example, the holder 24c is a fork having a pair of the prongs 26 spaced apart from each other on opposite sides of the longitudinal axis A16 of the shaft 16.

With continued reference to FIGS. 15 and 16, the shroud 28c of the shield 14c includes a cylindrical sidewall 32g having a plurality of the perforations 34 formed therethrough. Here, the perforations 34 are arranged into a regularly repeating pattern around the circumference of the sidewall 32g. For example, the perforations 34 may be arranged in a series of rows and/or columns that are regularly spaced around the entire circumference of the sidewall 32g.

In this example, the sleeve 30 may include a grasp element 42 disposed at an opposite end of the sleeve 30 from the shield 14c. In other examples, the grasp element 42 may be disposed at an intermediate portion of the sleeve 30, or may be disposed adjacent to the shield 14. The grasp element 42 is formed of a thermally-insulating material, and allows a user to grab the sleeve 30 to easily move the shield 14c between the first position and the second position.

In use, the utensil 10-10c is configured to provide a thermal buffer between a heat source and a food item to allow the food item to be cooked in a regulated manner over an open and unregulated heat source adjusting the position and/or orientation of the shield 14-14c. As used herein, the term “thermal buffer” refers to the effect of the shroud 28-28c to dampen or regulate the transfer of heat between the heat source and the food item by absorbing and deflecting heat from the heat source. For example, the shroud 28-28c may absorb the thermal energy from the flame or heat source and provide a relatively consistent emission of thermal energy to the food. However, when flare-ups occur at the heat source, the shroud 28-28c may deflect a portion of the thermal energy of the heat source and maintain a relatively consistent temperature within the shroud 28-28c. Accordingly, cooking of the food within the shroud 28-28c can be more easily controlled.

As discussed above, the amount of the thermal buffer provided by the shroud 28-28c can be adjusted by changing the configuration, position, and/or orientation of the shroud 28-28c relative to the flame. For example, as discussed above with respect to the various utensils 10-10c, the shroud 28-28c may be provided with perforations 34 that are sized and arranged to provide a desired thermal buffer between the food and the heat source. Larger perforations 34 and or a greater concentration of perforations 34 will allow a greater percentage of the food to be exposed directly to the heat source through the shroud 28-28c. Conversely, forming the shroud 28-28c with smaller perforations 34, a lower concentration of perforations 34, or no perforations 34 will provide a greater thermal buffer between the heat source and the food (whereby the utensil may, when the shroud and food item are positioned over an open flame, provide heating of the food item in a manner similar to a convection oven, with no direct exposure of the food item to the flame). Optionally, the size of the perforations may be different at different sections or regions or walls of the shroud, such that different sized perforations may be selectively positioned at the flame by a user of the utensil to achieve the desired degree of cooking of the food item. Optionally, for non-perforated shrouds having no perforations, the shroud may function to heat the food item over an open flame with no exposure of the food item to the open flame, thus providing convection heating of the food item.

Additionally or alternatively, the shield 14-14c may be moved to the retracted first position (FIGS. 9-11) to expose the holder 24-24c, thereby allowing food item to be presented directly to the heat source. The shield 14-14c may be moved to the extended second position (FIG. 12) to at least partially conceal the holder 24-24c and the food item. Furthermore, the shroud 28-28c may be rotated to selectively present one of a perforated first side 32a and an unperforated side 32b to the heat source (FIG. 1).

Therefore, the utensil comprises a shield or shroud that comprises a cylindrical or non-cylindrical metal sheet (e.g., aluminum), optionally with part of the shroud having holes or perforations. The perforations may be different sizes at different portions of the shroud, and optionally at least one portion of the shroud is not perforated. The metal sheet or shroud provides a barrier between the food item and the open flame to limit or preclude direct exposure of the food item to the open flame when the shroud and food item are disposed at the open flame. For perforated shrouds (or parts of shrouds), the holes or perforations provide for ventilation of the chamber or space circumscribed by the shroud (where the food item is disposed) and may allow for some flames to enter the space, but substantially limit direct exposure of the food item to the open flames. The holes or perforations are a small portion of the overall surface area of the metal sheet or shroud, such that the perforations may be less than 20 percent, such as less than 10 percent or less than 5 percent of the overall cylindrical surface area (i.e., the metal sheet encompasses greater than 80 percent or greater than 90 percent or greater than 95 percent of an overall cylindrical surface that would be provided by the sheet if there were no perforations).

During use of the utensil, the user can rotate the shroud to provide the desired heating of the food item. Optionally, the shroud may have different sized holes at different sides or regions of the shroud to provide further options to the user for selectively heating the food item. For example, one side or region may have very small perforations, and another side or region may have larger perforations.

Optionally, the shield or shroud may be removably disposed at the shaft, such that different shaped shrouds or different perforated shrouds may be movably disposed at the shaft to adapt the utensil for cooking a particular type of food item. For example, a rectangular shroud may be replaced by a cylindrical shroud when cooking smaller food items, or a shroud having larger perforations may be replaced with a shroud having smaller perforations or no perforations, depending on the type of heating/cooking desired. For example, the rectangular shroud may be used for cooking the likes of hot dogs while the cylindrical shroud may be used for cooking the likes of marshmallows or other smaller food items or food items that are held longitudinally along the tines of the holder. The holder may detach from the end of the shaft to allow the shield to be removed or replaced, or the sleeve may be adaptable to allow for detachably attaching the sleeve along the shaft.

The utensil may be commercialized and sold as a kit having a shaft (having a handle and food holder or forked end) and two or more shields or shrouds, such that the user can select the desired shroud depending on the type or size of the food item to be cooked. The kit may include two or more shield assemblies, whereby the shield assembly (including the sleeve and shroud attached to the sleeve via brackets) is detachably disposed at the shaft and removable from the shaft to swap out the shield assembly for different shroud shapes and/or shroud perforations or the like. Optionally, the kit may include two or more shrouds, which are detachably attached at the sleeve via common or respective brackets, such that the sleeve remains on the shaft, but the user can replace the shroud to use different shroud shapes and/or shroud perforations or the like.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

1. A utensil for cooking food disposed thereat, the utensil comprising:
a manipulator having a shaft and a holder disposed at a first end of the shaft;
a shield movably disposed on the shaft and including a shroud configured to at least partially conceal the holder when the shield is in an extended position and to expose the holder when the shield is in a retracted position;
wherein the holder is configured to hold a food item thereat;
wherein the shield comprises a metal sheet formed to at least partially circumscribe a longitudinal axis of the shaft; and
wherein, when the holder holds the food item and when the shield is in the extended position, the shield at least partially surrounds the food item and the holder.

2. The utensil of claim 1, wherein the shield includes a first side having a plurality of perforations formed therethrough.

3. The utensil of claim 2, wherein the shield includes a second side having no perforations.

4. The utensil of claim 2, wherein the perforations are arranged in a plurality of groups, adjacent ones of the groups being separated by an unperforated space.

5. The utensil of claim 1, wherein the shield is removably disposed on the shaft and is removable from the shaft.

6. The utensil of claim 1, wherein the shroud comprises a polygonal shroud having a plurality of sides that cooperate to circumscribe the food item when the shield is moved to the extended position.

7. The utensil of claim 1, wherein the shroud comprises a cylindrical shroud that circumscribes the food item when the shield is moved to the extended position.

8. The utensil of claim 1, wherein the holder includes at least one prong.

9. The utensil of claim 1, wherein the manipulator includes a handle disposed at a second end of the shaft.

10. The utensil of claim 1, wherein the shield includes a sleeve slidably disposed on the shaft and wherein the shroud is attached to the sleeve.

11. The utensil of claim 10, wherein the sleeve is configured to rotate about the shaft.

12. The utensil of claim 10, wherein rotation of the sleeve about the shaft is limited.

13. A method for cooking a food item over an exposed flame, the method comprising:
providing a cooking utensil comprising (i) a manipulator having a shaft and a holder disposed at a first end of the shaft, and (ii) a shield slidably disposed on the shaft, wherein the shield comprises a metal sheet providing a wall structure that circumscribes a longitudinal axis of the shaft;
moving the shield to a retracted position, whereby the holder is exposed;
disposing a food item at the holder;
after disposing the food item at the holder, moving the shield to an extended position to at least partially surround the holder and food item; and
cooking the food item by holding the shield and holder over an exposed flame, whereby the wall structure controls heating of the food item and limits direct exposure of the food item to the exposed flame.

14. The method of claim 13, wherein the wall structure has perforations established therethrough, and wherein the perforations vary in size at different regions of the wall structure, and wherein the method comprises rotating the shield to position different sized perforations at the exposed flame to adjust heating of the food item.

15. The method of claim 13, wherein a portion of the wall structure is perforated and another portion of the wall structure is not perforated, and wherein the method comprises rotating the shield to position the non-perforated portion or the perforated portion at the exposed flame to adjust heating of the food item.

16. The method of claim 15, wherein the perforated portion comprises at least two portions having different sized perforations, and wherein the method comprises rotating the shield to position different sized perforations at the exposed flame to adjust heating of the food item.

17. The method of claim 16, wherein the wall structure comprises a polygonal wall structure that circumscribes the food item when the shield is moved to the extended position.

18. The method of claim 16, wherein the wall structure comprises a cylindrical wall structure that circumscribes the food item when the shield is moved to the extended position.

19. The method of claim 13, wherein the wall structure comprises a polygonal wall structure that circumscribes the food item when the shield is moved to the extended position.

20. The method of claim 13, wherein the wall structure comprises a cylindrical wall structure that circumscribes the food item when the shield is moved to the extended position.
